(19) United States
(12) Patent Application Publication
(10) Pub. No.: US 2006/0222088 A1
(43) Pub. Date: Oct. 5, 2006

(54) Method of controlling digital image processing apparatus for convenient communication, and digital image processing apparatus using the method

(75) Inventor: Won-jung Kim, Seongnam-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/168,576

(22) Filed: Jun. 28, 2005

(30) Foreign Application Priority Data
Mar. 31, 2005 (KR) 10-2005-0027023

(51) Int. Cl. H04L 27/00

(52) U.S. Cl. 375/259

(57) ABSTRACT

Provided is a method of controlling a digital image processing apparatus that communicates with a device selected by a user from among a plurality of devices. The method includes: displaying a list of the plurality of devices when a cable connect signal for the communication with the selected device is generated; and communicating with the selected device through a preset communication protocol for the selected device when a selection signal indicating the selected device from among the plurality of devices is input by the user.

### BACKGROUND OF THE INVENTION

This application claims the priority of Korean Patent Application No. 10-2005-0027023, filed on Mar. 31, 2005, in the Korean Intellectual Property Office, the disclosure of which is incorporated herein in its entirety by reference.

1. Field of the Invention

The present invention relates to a method of controlling a digital image processing apparatus and a digital image processing apparatus using the method. More particularly, the present invention relates to a method of controlling a digital image processing apparatus that communicates with a device selected by a user from among a plurality of devices and to a digital image processing apparatus adopting the same.

2. Description of the Related Art

A typical digital image processing apparatus can communicate with one device, for example, a computer or a printing device, selected by a user. The general digital camera disclosed in U.S. Patent Publication No. 119,876, which is titled “Method of Notification of Inadequate Picture Quality” and was filed in 2004, is an example of such an apparatus.

When using a typical digital image processing apparatus, the user has to personally perform a setting mode and select one of a plurality of devices, for example, the computer or the printing device, by manipulating numerous buttons. This is because a communication protocol for each of the devices is different even if they share the same communication interface. Accordingly, the user has to check whether a desired device is currently selected before connecting a communication cable between the desired device and the digital image processing apparatus.

### SUMMARY OF THE INVENTION

The present invention provides a method of controlling a digital image processing apparatus and a digital image processing apparatus using the method. In the method, a user does not need to personally check whether a desired communication device is currently selected.

According to an embodiment of the present invention, there is provided a method of controlling a digital image processing apparatus that communicates with a device selected by a user from among a plurality of devices. The method comprises: (1) detecting the connection of a communication cable; (2) in response thereto, prompting a user to select a device from among a plurality of devices; (3) detecting a selection of the device by the user; and (4) communicating with the selected device using a preset communication protocol for the selected device.

According to another embodiment of the present invention, there is provided a digital image processing apparatus including: a controller, a communication port, and a display unit. The controller performs communication via the communication port with a device selected by a user from among a plurality of devices. Here, the controller performs steps comprising: (1) detecting the connection of a communication cable; (2) in response thereto, prompting a user to select a device from among a plurality of devices; (3) detecting a selection of the device by the user; and (4) in response thereto, communicating with the selected device by a preset communication protocol for the selected device.

According to the method of controlling the digital image processing apparatus and the digital image processing apparatus using the method, the user can select a device with which to communicate from the list of the plurality of devices displayed on the display unit after connecting a communication cable. Therefore, the user does not need to personally check whether a desired communication device is currently selected on the digital image processing apparatus prior to connecting a device.

### BRIEF DESCRIPTION OF THE DRAWINGS

The above and other features and advantages of the present invention will become more apparent by describing in detail exemplary embodiments thereof with reference to the attached drawings in which:

FIG. 1 is a rear view of a digital camera, which is a digital image processing apparatus, according to an embodiment of the present invention;

FIG. 2 is a block diagram of the digital camera of FIG. 1;

FIG. 3 is a flow chart illustrating an embodiment of a main program of the digital signal processor (DSP) shown in FIG. 2;

FIG. 4 is a flow chart illustrating a program performed in the preview mode of the method illustrated in FIG. 3;

FIG. 5 is a flow chart illustrating an embodiment of a program performed in the image photographing mode of the method illustrated in FIG. 3;

FIG. 6 is an exemplary view of the digital camera and a printer or the digital camera and a computer interconnected via a USB cable when the cable connect signal mentioned in FIG. 3 is generated;

FIG. 7 is a flow chart illustrating an embodiment of a program performed in the communication mode of the method illustrated in FIG. 3; and

FIGS. 8 and 9 are views illustrating pop-up boxes that are displayed on a color LCD panel by detecting direction signals and moving the activated cursor mentioned in FIG. 7, according to an embodiment of the present invention.

### DETAILED DESCRIPTION OF THE INVENTION

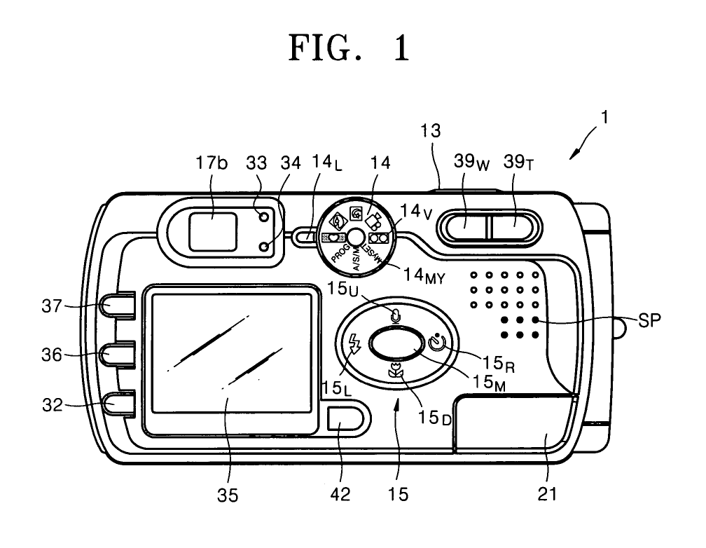

Referring to FIG. 1, a digital camera 1, which is a digital image processing apparatus according to an embodiment of the present invention, includes a shutter release button 13, a mode dial 14, a mode indicating lamp 14_{L}, function buttons 15, a manual focus/delete button 36, a manual adjust/play/stop button 37, a play mode button 42, a speaker SP, a monitor button 32, an automatic focus lamp 33, a view finder 17b, a flash standby lamp 34, a color liquid crystal display (LCD) panel 35, a wide-angle zoom button 39_{W}, a telephoto zoom button 39_{T}, and an external interface unit 21.

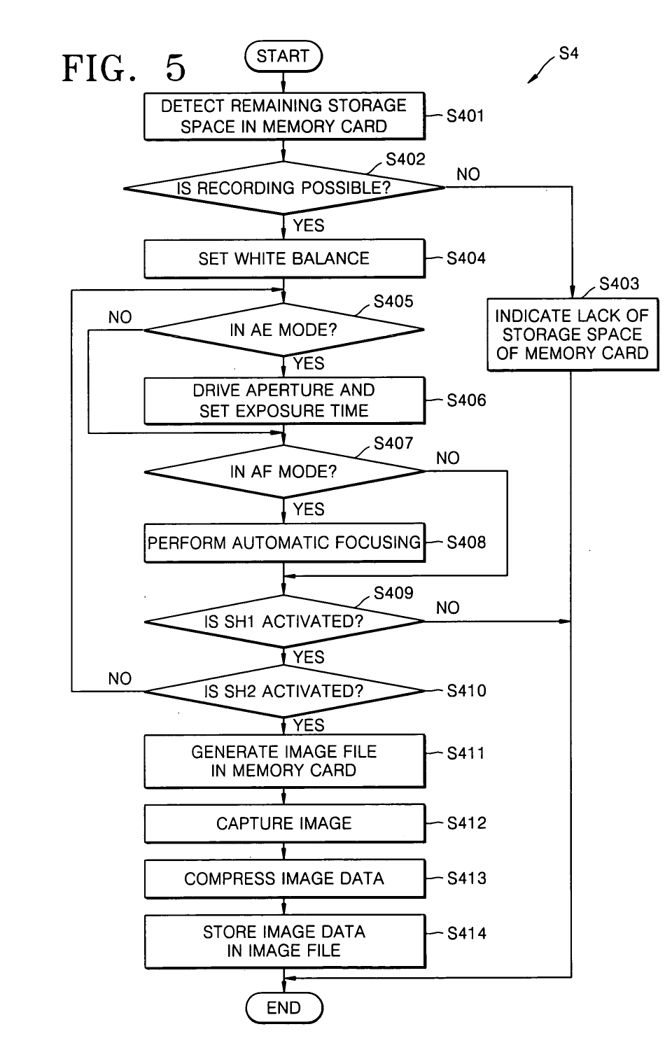

The shutter release button 13 has a two-level structure. That is, if the user presses the shutter release button 13 down to a first level, a first signal SH1 transmitted from the shutter release button 13 is activated, and if the shutter release button 13 is pressed down to a second level, a second signal SH2 transmitted from the shutter release button 13 is activated (refer to FIG. 5).

The mode dial 14 is used to select an operating mode among a plurality of operating modes of the digital camera 1. The plurality of operating modes may include, for example, a simple image photographing mode, a program image photographing mode, a portrait image photographing mode, a night scene image photographing mode, a manual image photographing mode, a moving picture photographing mode 14_{MP}, a personal loading mode 14_{MY}, and an audio recording mode 14_{V}.

The personal loading mode 14_{MY} is an operating mode in which personal photographing settings of the user stored in a storage medium, for example, a memory card, are loaded and used to perform photographing. Meanwhile, the audio recording mode 14_{V} is an operating mode in which only sounds, for example, the user's voice, are recorded.

The function buttons 15 are used to perform specific functions of the digital camera 1 as well as to move an activated cursor on a menu screen of the color LCD 35. The function buttons 15 include a self-timer/right button 15_{R}, a flash/left button 15_{L}, a macro/down button 15_{D}, a voice-memo/up button 15_{U}, and a menu/select-confirm button 15_{M}.

The manual adjust/play/stop button 37 is used to manually adjust particular conditions. Also, if the user presses the manual adjust/play/stop button 37 when a moving picture file is selected in a play mode, the selected moving picture file is played or stopped.

The manual focus/delete button 36 is used to manually focus or delete an image in an image photographing mode.

The monitor button 32 is used to control the operation of the color LCD panel 35.

The play mode button 42 is used to convert to the play mode or the preview mode.

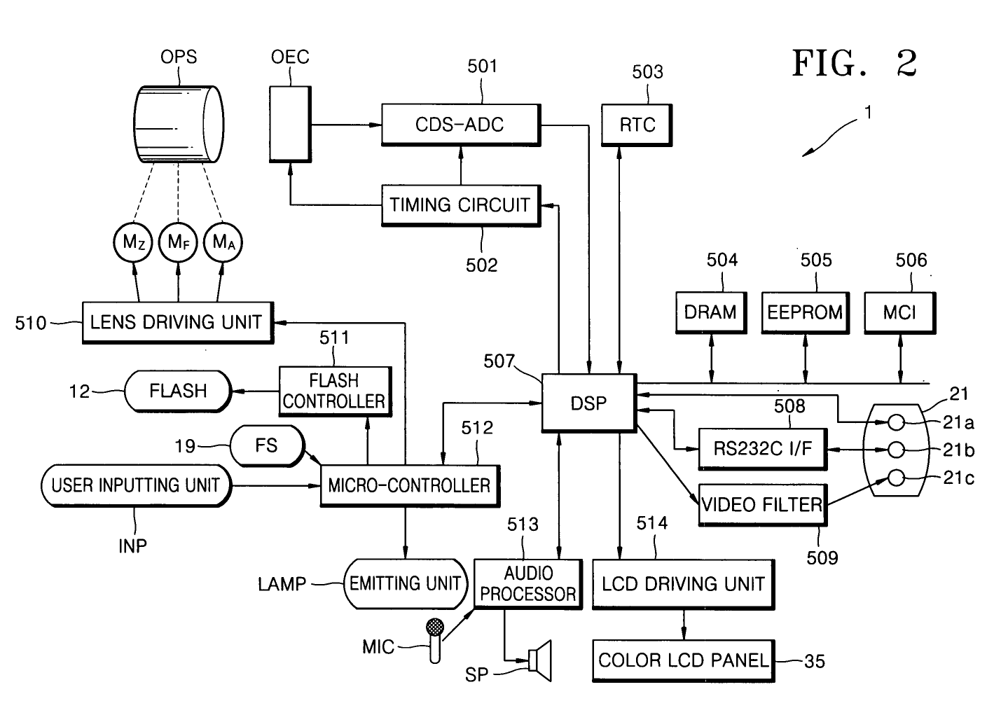

The automatic focus lamp 33 operates when the digital camera 1 is well focused. The flash standby lamp 34 operates when a flash 12 (see FIG. 2) is in standby mode. The mode indicating lamp 14_{L} indicates a selected mode of the mode dial 14.

FIG. 2 is a block diagram of the digital camera 1 of FIG. 1. Referring to FIGS. 1 and 2, the overall structure and operation of the digital camera 1 will now be described.

An optical system OPS that includes a lens unit (not shown) and a filter unit (not shown) optically processes light reflected from a subject.

The lens unit of the optical system OPS includes a zoom lens, a focus lens, and a compensation lens.

When the user presses the wide-angle zoom button 39_{W} or the telephoto zoom button 39_{T} included in a user input unit INP, a signal corresponding to the wide-angle zoom button 39_{W} or the telephoto zoom button 39_{T} is input to a micro-controller 512. Accordingly, as the micro-controller 512 controls a lens driving unit 510, a zoom motor M_{Z} is driven and moves the zoom lens.

In an automatic focus mode, a main controller (not shown) included in a digital signal processor (DSP) 507 controls the lens driving unit 510 via the micro-controller 512, and thus a focus motor M_{F} is operated. Accordingly, the focus lens moves, and in this process, the location of the focus lens at which a high frequency component of an image signal increases the most, for example, a number of levels of the focus motor M_{F}, is set.

The compensation lens of the optical system OPS compensates the overall refractive index of the optical system OPS, and thus is not operated separately. A motor M_{A} is for driving an aperture (not shown).

A photoelectric converter OEC of a charge-coupled device (CCD) or a complementary metal oxide semiconductor (CMOS) (not shown) converts light received from the optical system OPS into electrical analog signals. Here, the DSP 507 controls a timing circuit 502, which controls the operation of the photoelectric converter OEC and a correlation double sampler and analog-to-digital converter (CDS-ADC) 501. The CDS-ADC 501 processes the analog signals received from the photoelectric converter OEC and converts them into digital signals after removing high frequency noise and altering their bandwidth.

A real-time clock (RTC) 503 provides time information to the DSP 507. The DSP 507 processes the digital signals output from the CDS-ADC 501 and generates digital image signals that are divided into brightness and chromaticity signals.

An emitting unit LAMP, which is operated by the micro-controller 512 according to control signals received from the DSP 507 including the main controller, includes a self-timer lamp (not shown), the automatic-focus lamp 33, the mode indicating lamp 14_{L}, and the flash standby lamp 34. The user input unit INP includes the shutter release button 13, the mode dial 14, the function buttons 15, the monitor button 32, the manual focus/delete button 36, the manual adjust/play/stop button 37, the wide-angle zoom button 39_{W}, the telephoto zoom button 39_{T}, and the play mode button 42.

The digital image signals transmitted from the DSP 507 are temporarily stored in a dynamic random-access memory (DRAM) 504. Programs and setting information needed for the operation of the DSP 507 are stored in an electrically erasable and programmable read-only memory (EEPROM) 505. In an embodiment, a removable memory card is inserted into a memory card interface (MCI) 506.

The digital image signals from the DSP 507 are input to an LCD driving unit 514, and an image is displayed on the color LCD panel 35.

The digital image signals output from the DSP 507 can be transmitted in series via a universal serial bus (USB) connector 21a or an RS232C interface 508 and its connector 21b. They can also be transmitted as video signals via a video filter 509 and a video outputting unit 21c.

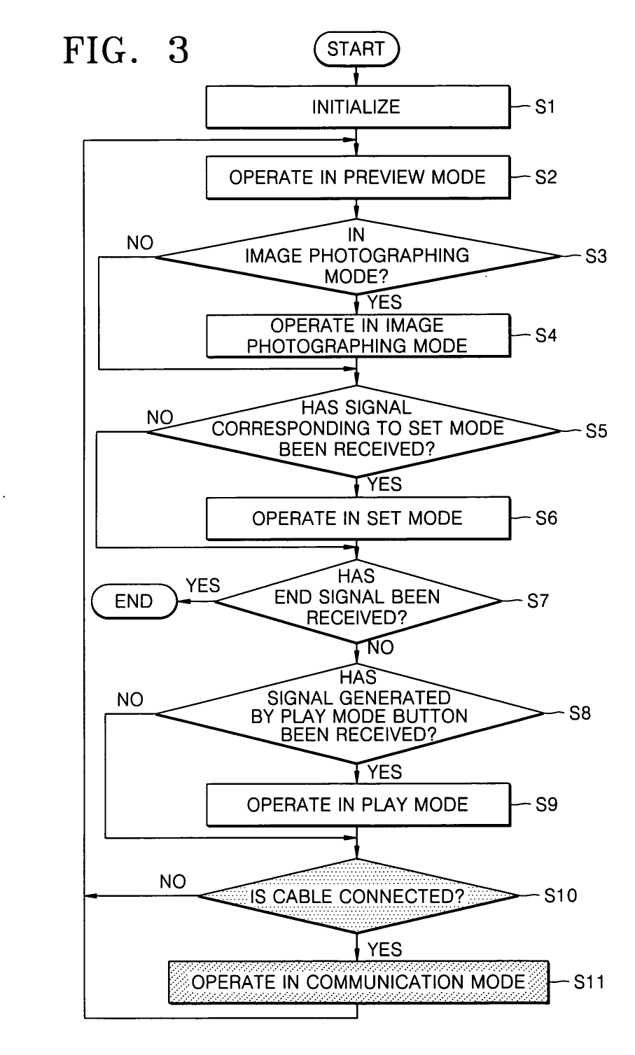

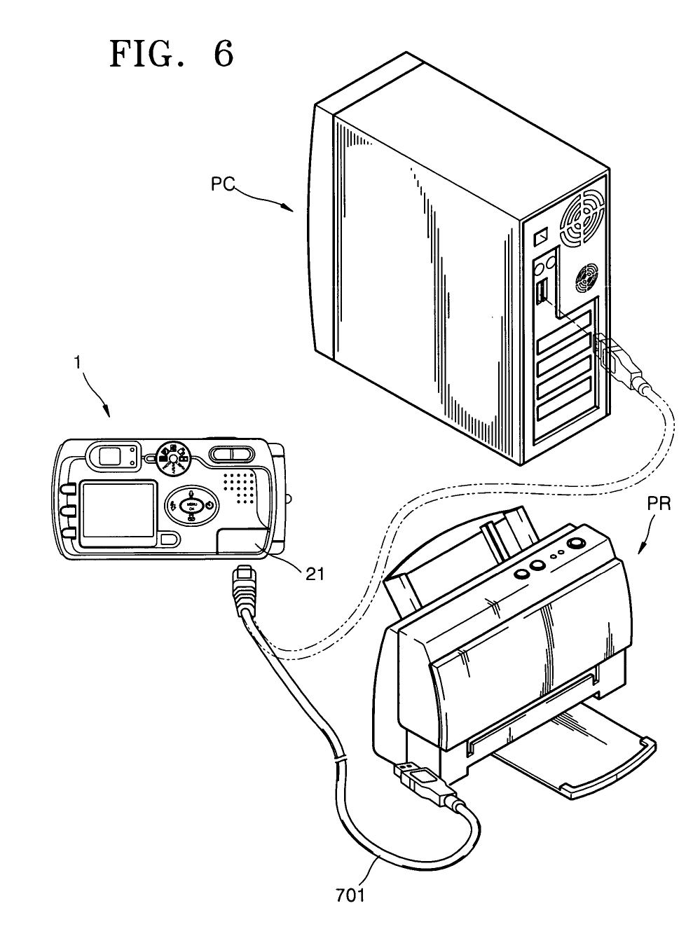

For example, the DSP 507 may perform USB communication with a printer or a computer (see FIG. 6). Programs performing in this communication mode are described in more detail with reference to FIGS. 3 and 6 through 9.

An audio processor 513 outputs audio signals from a microphone MIC to the DSP 507 or to the speaker SP. The audio processor 513 also outputs audio signals from the DSP 507 to the speaker SP.

Meanwhile, the micro-controller 512 operates the flash 12 by controlling the operation of a flash controller 511 according to a signal output from a flash light sensor (FS) 19.

An embodiment of the main program performed in operating the DSP 507 illustrated in FIG. 2 will be described with reference to FIGS. 1 through 3.

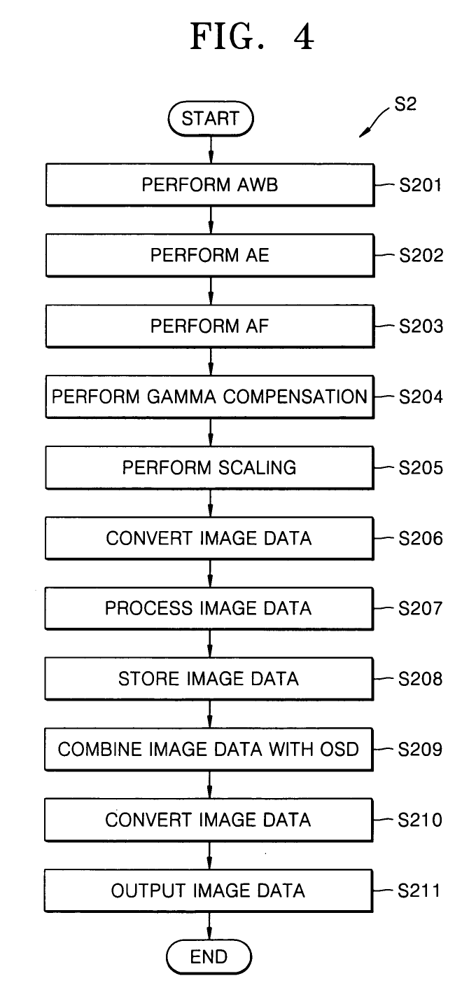

When power is supplied to the digital camera 1, the DSP 507 performs initialization (S1). When the initialization (S1) is performed, the DSP 507 operates in the preview mode (S2). In the preview mode, an input image is displayed on the color LCD panel 35. Operations related to this preview mode will be described in more detail with reference to FIG. 4 later.

Next, when the user presses the shutter release button 13 down to the first level and the first signal SH1 transmitted from the shutter release button 13 is activated (S3), the DSP 507 operates in the current image photographing mode (S4). The steps performed in the current image photographing mode (S4) will be described in more detail with reference to FIG. 5 later.

When signals corresponding to a setting mode are received (S5) from the user input unit INP, the setting mode is performed to set operating conditions according to the input signals output from the user input unit INP (S6).

If an end signal is not generated (S7), the DSP 507 then performs the following operations.

First, if a signal is output from the play mode button 42 included in the user input unit INP (S8), the DSP 507 performs the play mode (S9). In the play mode, the play operations are performed according to the input signals output from the user input unit INP.

Meanwhile, if a cable connect signal is generated via the USB connector 21a or the RS232C interface 508 and its connector 21b from the outside (S10), the DSP 507 performs a communication mode (S11). The steps performed in the communication mode (S11) will be described later with reference to FIGS. 6 through 9.

If the communication mode is terminated, operations S2 through S11 are repeated.

Referring to FIGS. 1 and 2, and 4, in an embodiment of the preview mode (S2) of FIG. 4, the DSP 507 first performs automatic white balancing (AWB) and sets parameters related to the white balance (S201).

Then, an automatic exposure (AE) mode is performed (S202). The DSP 507 calculates the brightness of incident light, drives the aperture driving motor M_{A} according to the calculated brightness of incident light, and sets an exposure time (S203).

Then, the DSP 507 performs gamma compensation on the input image data (S204) and scales the gamma compensated input image data so that the image fits the display (S205).

Next, the DSP 507 converts the scaled input image data from red-green-blue image data to brightness-chromaticity image data (S206). The DSP 507 processes the input image data in relation to, for example, a resolution and a display location, and performs filtering (S207).

Afterwards, the DSP 507 temporarily stores the input image data in the DRAM 504 (see FIG. 2) (S208).

The DSP 507 combines the input image data temporarily stored in the DRAM 504 with on-screen display (OSD) data (S209). The DSP 507 converts the combined image data from brightness-chromaticity image data to red-green-blue image data (S210) and outputs the red-green-blue image data to the LCD driving unit 514 (see FIG. 2) (S211).

FIG. 5 is a flow chart illustrating an embodiment of the image photographing mode (S4) of the method illustrated in FIG. 3. The image photographing mode (S4) will be described with reference to FIGS. 1 and 2, and FIG. 5. Here, the current location of the zoom lens is already set.

First, the DSP 507 detects the remaining storage space in the memory card (S401) and checks whether the remaining storage space is sufficient to store a digital image (S402). If there is not enough storage space, the DSP 507 indicates lack of storage space in the memory card and then terminates the image photographing mode (S403). If there is enough storage space, the following operations are performed.

First, the DSP 507 performs white balancing according to the photographing conditions that are currently set and sets parameters related to the white balance (S404).

Then, when in an AE mode (S405), the DSP 507 calculates the brightness of the incident light, drives the aperture driving motor M_{A} according to the calculated brightness, and sets an exposure time (S406).

When in an AF mode (S407), the DSP 507 performs automatic focusing and drives the focus lens (S408).

The DSP 507 continues to perform the following operations if the first signal SH1 from the shutter release button 13 is activated (S409).

First, the DSP 507 determines whether the second signal SH2 is activated (S410). If the second signal SH2 is not activated, the DSP 507 repeats operations S405 through S410 since the user has not pressed the shutter release button 13 to the second level for photographing.

If the second signal SH2 is activated, the DSP 507 generates an image file in the memory card, which, in an embodiment, is the storage medium, since the user has pressed the shutter release button 13 to the second level for photographing (S411). The DSP 507 continually captures an image (S412). That is, the DSP 507 receives still image data from the CDS-ADC 501. Then, the DSP 507 compresses the received image data (S413) and stores the compressed image data as the image file (S414).

FIG. 6 is an exemplary view of the digital camera 1 and a printer PR or the digital camera 1 and a computer PC being interconnected via a USB cable 701 when the cable connect signal in operation S10 of FIG. 3 is generated.

For example, when the USB connector 21a (see FIG. 2) included in the external interface 21 of the digital camera 1 and a USB connector (not shown) of the printer PR are interconnected via the USB cable 701, the cable connect signal in operation S10 is generated.

When the cable connect signal is generated, the DSP 507 operates in the communication mode (S11).

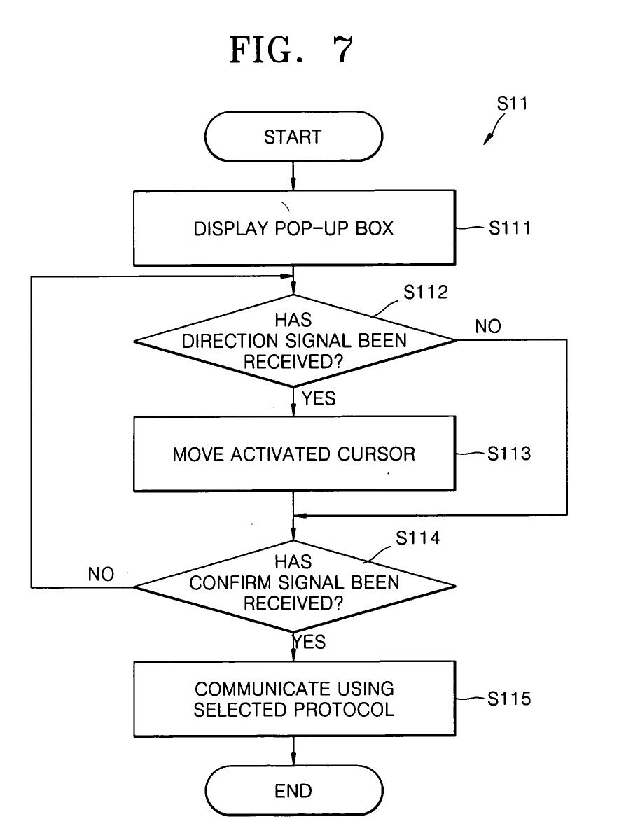

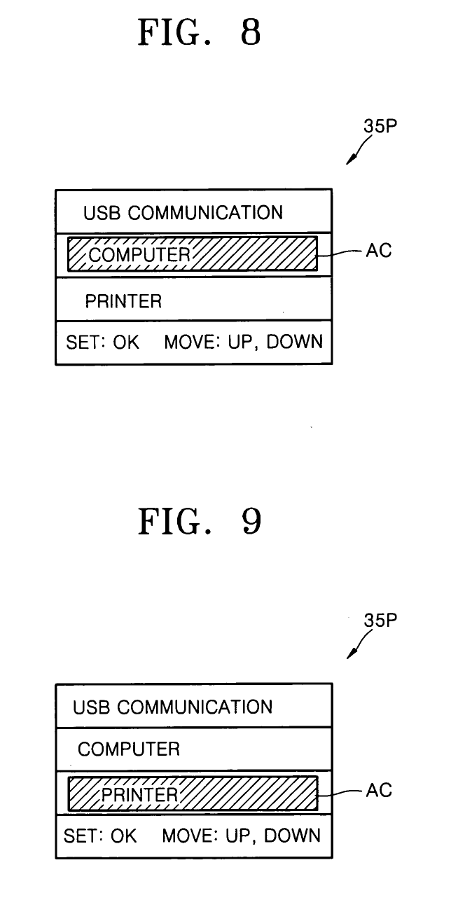

FIG. 7 is a flow chart illustrating an embodiment of the program performed in the communication mode (S11) mentioned in FIG. 3. FIGS. 8 and 9 are views illustrating pop-up boxes 35P. In an embodiment of the present invention, the pop-up boxes 35P are displayed on the color LCD panel 35. In an embodiment, the pop-up boxes 35P contain device selection menus or lists of external devices such as a computer PC and a printer PR. In response to the detection of a direction signal (S112), the activated cursor AC (S113) mentioned in FIG. 7 is moved to select an option on the menu. Referring to FIGS. 6 through 9, the program performed in the communication mode S11 is as follows.

When the cable connect signal for communication as in operation S10 in FIG. 3 is input via a communication port such as the USB connecter 21a (see FIG. 2), the DSP 507 displays the pop-up box 35P in which a list of a plurality of devices including the computer PC and the printer PR are listed on the color LCD panel 35 (see FIG. 1) (S11). Here, the activated cursor AC is also displayed to activate one of the plurality of devices.

Then, when the direction signals are generated by pressing the macro-down button 15_{D} or the audio-memo/up button 15_{U} (S112), the DSP 507 moves the activated cursor AC according to the direction of the input direction signal (S113) (see FIGS. 8 and 9).

Next, when a selection signal is input to select a device with which to communicate from among the plurality of devices, for example, the computer PC and the printer PR, by pressing the menu/select-confirm button 15_{M} (S114), communication is performed using a preset communication protocol for the selected device (S115).

Consequently, the user can select one device from the list of the pop-up box 35P that is displayed after connecting the communication cable, for example, the USB cable 701.

As described above, according to a method of controlling a digital image processing apparatus for convenient communication, and a digital image processing apparatus using the method, a user can select a device from a list of a plurality of devices displayed after connecting a communication cable. Therefore, the user does not need to check whether or not a communication device the user desires is currently selected on the digital camera prior to connecting the communication cable.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of controlling a digital image processing apparatus, the method comprising:
detecting the connection of a communication cable;
in response thereto, prompting a user to select a device from among a plurality of devices;
detecting a selection of the device by the user; and
communicating with the selected device using a preset communication protocol for the selected device.

2. The method of claim 1, wherein a device selection signal is generated in response to a user input.

3. The method of claim 2, wherein the user input comprises manipulation of a button.

4. The method of claim 1, wherein the plurality of devices comprises a computer and a printer.

5. The method of claim 1, further comprising displaying a device selection menu comprising a list of the plurality of devices.

6. The method of claim 5, wherein the device selection menu is displayed in a pop-up box.

7. The method of claim 5, wherein a movable activated cursor is placed over a menu item representing one of the plurality of devices.

8. The method of claim 7, further comprising:
detecting a direction signal;
moving the activated cursor in response to the direction signal;
detecting a confirmation signal; and
in response thereto, selecting the selected device.

9. The method of claim 8, wherein the direction signal is generated in response to a user input.

10. The method of claim 9, wherein the user input comprises manipulation of a button.

11. The method of claim 8, wherein the confirmation signal is generated in response to a user input.

12. A digital image processing apparatus, the apparatus comprising
a communication port;
a display unit; and
a controller that performs communication via the communication port with a device selected by a user from among a plurality of devices, wherein the controller performs steps comprising:
(a) detecting the connection of a communication cable;
(b) in response thereto, prompting a user to select a device from among a plurality of devices;
(c) detecting a selection of the device by the user;
(d) in response thereto, communicating with the selected device by a preset communication protocol for the selected device.

13. The apparatus of claim 12, wherein a communication cable connect signal is input via the communication port.

14. The apparatus of claim 12, wherein the user selects the device by manipulating a button.

15. The apparatus of claim 12, further comprising:
a lens unit that receives light from a subject to be photographed by the apparatus; and
a photoelectric device that converts the received light to analog electrical signals;
an analog-to-digital converter that converts the analog electrical signals to digital signals for processing by the controller.

16. The apparatus of claim 12, wherein the plurality of devices comprises a computer and a printer.

17. The apparatus of claim 12, further comprising the controller performing the step of displaying a device selection menu comprising a list of the plurality of devices.

18. The apparatus of claim 17, wherein the device selection menu is displayed in a pop-up box.

19. A method of controlling a digital image processing apparatus, the method comprising:
detecting the connection of a device to the apparatus;
displaying on a display a list of external devices with which the apparatus could be connected;
detecting a first user input;
in response to the first user input, moving a cursor on the display such that the connected device is highlighted;
detecting a second user input;
in response to the second user input, communicating with the highlighted device using a corresponding preset communication protocol, wherein the communication protocol is different from he communication protocols that are used to communicate with the other external devices on the list.

20. The method of claim 19, wherein the list of external devices comprises a printer and a computer.
